(19) United States
(12) Patent Application Publication
(10) Pub. No.: US 2021/0359899 A1
(43) Pub. Date: Nov. 18, 2021

(54) Managing Event Data in a Network

(71) Applicant: Telefonaktiebolaget LM Ericsson (PUBL), Stockholm (SE)

(72) Inventor: MingXue WANG, County Westmeath (IE)

(21) Appl. No.: 17/274,081

(22) PCT Filed: Sep. 11, 2018
(86) PCT No.: PCT/EP2018/074468

§ 371 Date: Mar. 5, 2021

(51) Int. Cl. H04L 12/24

(52) U.S. Cl. CPC H04L 41/0609; H04L 41/0631; H04L 41/0618

(57) ABSTRACT

A method (100, 200, 300) for managing network event data are disclosed. The method for managing network event data comprises receiving incoming network event data, the network event data comprising notifications of network events occurring within a network (102). The method further comprises, for individual notified network events within the received network event data, identifying a category of the notified network event (104) and filtering the received network event data on the basis of co-occurrence in the network of network events in individual network categories with network events in other network categories (106). Also disclosed are a Manager (600), a System (700) and a computer program.

### TECHNICAL FIELD

The present disclosure relates to a method and system for managing network event data. The present disclosure also relates to a manager, a system and a computer program product configured to carry out a method for managing network event data.

### BACKGROUND

Managed networks, such as telecommunication and computer networks, are continually evolving, increasing in size and complexity to meet consumer demand. Network evolution over recent years has been such that millions of network events may now take place in a single managed network every day. Some of the more common network events include alarms, logs, alerts and notifications, which may be generated as a result of a fault within the network or as part of operations and performance monitoring within the network. Managing the vast quantity of network event data that is generated on a daily basis is an ongoing challenge for network operators. Analysis of network event data is a particularly important challenge for diagnosing problems that occur in a network. Owing to the large number of events that may occur at any given time, analyzing network event data in an attempt to determine the root cause of a problem can be extremely difficult. The nature of many managed networks is such that a significant number of network events may be generated as a consequence of a single network issue or problem. For example a single failed link may result in alarm messages from nodes on either side of the link, failure or alarm messages from services or applications whose traffic was carried over the link, and notifications from other nodes, applications and services which may be affected by rerouting of traffic around the failed link. Identifying from amongst the mass of network event data those network events related to a single network problem, and analyzing those identified events to determine the root cause of the problem, is a complex task for network operators requiring extensive input from domain experts.

Current approaches to the management of network event data are typically based around an error management system which is designed for the needs of a specific network. The creation and management of such systems requires expert-level knowledge of network operation, as well as detailed knowledge of network topology and deployment. Such network specific design is nontransferable between networks, and requires ongoing input from experts to accommodate network evolution over time. However, with network size and complexity increasing year on year, relying on network operator expertise is increasingly problematic. It is desirable to provide more intelligent and automated systems for network event data management. There is an increasing interest in the field in the provision of Artificial Intelligence (AI) and machine learning approaches that can provide intelligent automation of different aspects of network event data management.

One application in which AI and machine based learning approaches may be useful for network event data management is in a Fault Management (FM) system of an Operations Support System (OSS). AI and machine learning may assist in the creation of alarm filters which may then be applied to service models or metamodel classes to select a subset of received alarms. Alarms may be filtered using criteria based on one or more alarm properties, such as severity, element name, etc. Such filtering provides a way to control the alarms or other data seen by a user when they investigate the source of a particular issue in the network. Alarm suppression logic can be built based on expert-defined operating conditions, such as service impacts, unplanned events, etc. A user may seek to adjust alarm suppression criteria, such that data that may provide useful intelligence on the root cause of a problem is maintained, and other less relevant data is suppressed. The definition of “relevant” data for any given analysis task may vary, but a common approach is to classify any event that occurs when there is no service degradation situation in the network as a “noise” event, and to seek to filter out the data relating to such noise events when seeking to diagnose a problem in the network.

Some FM systems may use pattern mining with expert correlation analysis approaches, such as the system disclosed in Laumonier, Y., et al. “Towards Alarm Flood Reduction” in 22nd IEEE International Conference on Emerging Technologies And Factory Automation, 2017. Such approaches require network experts to analyze mined frequent event data or alarm pattern data and to identify noise events using their knowledge of the network.

Other FM systems use supervised machine learning approaches, in which the FM system learns which alarms may be classified as noise events during alarm flood periods. These systems require domain experts to identify and label alarm flood periods in historical network event data so as to provide sufficient training data for the initial training of the system using supervised machine learning algorithms.

The above discussed existing approaches to the integration of AI and machine learning in FM systems remain highly dependent on expert knowledge of network operation and detailed information about network deployment, and require a high degree of involvement from the network operator for implementation. Such expert knowledge and network information may not remain constant or be available at all times in a dynamic, heterogeneous and multivendor network environment. For example, service impact/degradation key performance indicators (KPIs) may be unavailable or may differ for different networks or network domains. Network topology information may be frequently changing or may be unavailable. A network may be reconfigured when new alarm logic is introduced. Existing methods therefore demonstrate several drawbacks in their approach to the integration of AI and machine learning in network data management.

### SUMMARY

It is an aim of the present disclosure to provide a method and apparatus which obviate or reduce at least one or more of the disadvantages mentioned above.

According to a first aspect of the present disclosure, there is provided a method for managing network event data. The method comprises receiving incoming network event data, the network event data comprising notifications of network events occurring within a network. The method further comprises, for individual notified network events within the received network event data, identifying a category of the notified network event and filtering the received network event data on the basis of co-occurrence in the network of network events in individual network categories with network events in other network categories. For the purposes of the present disclosure, a co-occurrence of two or more network events may comprise an occurrence or happening of each of the two or more network events during a predetermined time period. According to some examples, the predetermined time period may be selected by an operator or administrator according to the operation of a particular network. For the purposes of the present disclosure, a co-occurrence in the network of a network event in an individual network category with a network event in another network category may therefore comprise an occurrence or happening of a network event in the individual category and an occurrence or happening of a network event in the other network category during a predetermined time period. In some examples, the predetermined time period may be a co-occurrence time period which may be defined as set out in further detail below.

According to examples of the present disclosure, filtering the received network event data on the basis of co-occurrence in the network of network events in individual network categories with network events in other network categories may comprise prioritising notified network events belonging to categories for which a measure of co-occurrences in the network of network events in the category with network events in other network categories is lowest. According to examples of the present disclosure, the measure of co-occurrences may comprise a count of a total number of co-occurrences in the network of network events in the category with network events in other network categories. According to further examples of the present disclosure, the measure of co-occurrences may comprise a count of a total number of categories containing events with which events in the category co-occur in the network. According to further examples of the present disclosure the measure may place increased importance on co-occurrence with events in categories that themselves contain events which co-occur with events in many other categories. According to further examples of the present disclosure, the measure may comprise a noise score, as discussed in further detail below.

According to examples of the present disclosure, filtering the received network event data on the basis of co-occurrence in the network of network events in individual network categories with network events in other network categories may further comprise filtering based on co-occurrence of events in individual event categories with network events in all other categories of network event.

According to examples of the present disclosure, identifying a category of a notified network event may comprise determining a category of network events to which the notified network event corresponds, and assigning the notified network event to the determined category.

According to examples of the present disclosure, the method may further comprise defining categories of network events based on at least one of historical network event data and/or real-time incoming network event data. In other examples, predefined default categories may be used.

According to examples of the present disclosure, defining categories of network events may comprise: identifying attributes of network events, selecting an identified attribute for category definition, and specifying individual categories of network events corresponding to different possible values of the selected attribute.

According to examples of the present disclosure, identifying a category of a notified network event may comprise determining a value of the selected attribute for the notified network event, and assigning the notified network event to the defined category of network events that corresponds to the determined value.

According to examples of the present disclosure, the attribute may indicate a source of the network event. According to examples of the present disclosure, a source of a network event may comprise an identification or characterisation of a part of the network in which the event originated. The part of the network may be identified or characterised using hardware, software, network partition, network topology etc. Examples of a network event attribute indicating a source of the network event may include node ID, node type, application ID, application type, network layer etc.

According to examples of the present disclosure, the attribute may indicate a type of the network event. According to examples of the present disclosure, a type of a network event may comprise an identification or characterisation of a class or family of events to which the event belongs. Examples of a network event attribute indicating a type of the network event may include probable cause, specific problem, alarm severity etc.

According to examples of the present disclosure, the method for managing network event data may further comprise determining a noise score for categories of network events occurring in the network, wherein the noise score of a network event category is based on co-occurrence of network events in the category with network events in other categories. According to such examples of the present disclosure, the method may further comprise, for individual notified network events within the received network event data, associating the determined noise score for the category to which the notified network event belongs with the notified network event. According to such examples of the present disclosure, filtering the received network data may comprise filtering the notified network events based upon their associated category noise score.

According to examples of the present disclosure, filtering the received network event data may comprise, for individual notified network events within the received network event data, comparing the category noise score associated with the notified network event to a threshold, and forwarding the notified network event for processing if the noise score is below the threshold.

According to examples of the present disclosure, determining a noise score for categories of events occurring in the network may comprise determining the noise score based on co-occurrence of events in individual event categories with network events in all other categories of network event.

According to examples of the present disclosure, determining a noise score for categories of network events occurring in the network may comprise determining a noise score for each category of network event occurring in the network.

According to examples of the present disclosure, determining a noise score for categories of network events occurring in the network may comprise determining a noise score based on historic network event data.

According to examples of the present disclosure, determining a noise score for categories of network events occurring in the network may further comprise determining the noise score on the basis of network event data representing network events that occurred over a training time period.

According to examples of the present disclosure, the method for managing network event data may further comprise updating a noise score of at least one network event category on occurrence of an update trigger.

According to examples of the present disclosure, the update trigger may comprise at least one of: a time based trigger or an event based trigger.

According to examples of the present disclosure, determining a noise score for categories of network events occurring in the network may comprise generating a temporal association graph of network event categories, wherein the temporal association graph comprises a weighted graph having a vertex set of network event categories and an edge set of association relations between network event categories.

According to examples of the present disclosure, generating a temporal association graph of network event categories may comprise determining an association relation between network event categories according to a number of co-occurrences in the network of network events in the categories, wherein a co-occurrence of network events in two network event categories comprises occurrence of an event in each of the network event categories within a co-occurrence time window.

According to examples of the present disclosure, an association relation between categories of network events may be determined according to:

$${e}_{ij} = {\sum }_{k = 1}^{n} min ( {v}_{i}^{wk} , {v}_{j}^{wk} )$$

Where:

vᵢ and vⱼ are two categories of network event;
eᵢⱼ is the association relation between the network event categories vᵢ and vⱼ;
wk is a co-occurrence time window;
vᵢ^{wk}, vⱼ^{wk} are occurrence counts of events in event categories vᵢ and vⱼ during the co-occurrence time window wk, and
n is the total number of co-occurrence time windows in a training time period.

According to examples of the present disclosure, determining a noise score for categories of network events occurring in a network may further comprise calculating a Markov model based on the temporal association graph.

According to examples of the present disclosure, the Markov model may be calculated using the expression:

M=D⁻¹A

Where:

M is the Markov model;
D is the out degree matrix of the temporal association graph; and
A is the weight adjacency matrix of the temporal association graph.

According to examples of the present disclosure, the Markov model may comprise an eigenvalue equal to 1, and determining a noise score for categories of network events occurring in the network may further comprise setting an eigenvector of the Markov model that corresponds to the eigenvalue of 1 to be a noise score vector of the network noise event categories represented in the temporal association graph.

According to examples of the present disclosure, the method of managing network events may further comprise calculating entries of the noise score vector according to the expression:

$${n}_{i} = {\sum }_{j} {e}_{ji} \frac{{n}_{i}}{{Σ}_{i} {e}_{ji}}$$

According to examples of the present disclosure, determining a noise score for categories of network events occurring in the network may comprise normalizing the noise score vector.

According to examples of the present disclosure, the network event data may comprise notifications of network events, and a network event may comprise at least one of an alarm, a fault, and/or a performance event.

According to another aspect of the present disclosure, there is provided a computer program comprising instructions which, when executed on at least one processor, cause the at least one processor to carry out a method according to any one of the preceding aspects and/or examples of the present disclosure.

According to another aspect of the present disclosure, there is provided a carrier containing a computer program according to the preceding aspect of the present disclosure, wherein the carrier comprises one of an electronic signal, optical signal, radio signal or computer readable storage medium.

According to another aspect of the present disclosure, there is provided a computer program product comprising non-transitory computer readable media having stored thereon a computer program according to a preceding aspect of the present disclosure.

According to another aspect of the present disclosure, there is provided a manager for managing network event data, the manager comprising a processor and a memory, the memory containing instructions executable by the processor such that the manager is operable to: receive incoming network event data, the network event data comprising notifications of network events occurring within a network, for individual notified network events within the received network event data, identify a category of the notified network event, and filter the received network event data on the basis of co-occurrence in the network of network events in individual network categories with network events in other network categories.

According to examples of the present disclosure, the memory may further comprise instructions executable by the processor such that the manager is operable to carry out a method according to any one of the preceding aspects or examples of the present disclosure.

According to another aspect of the present disclosure, there is provided a manager for managing network event data, the manager adapted to: receive incoming network event data, the network event data comprising notifications of network events occurring within a network, for individual notified network events within the received network event data, identify a category of the notified network event, and filter the received network event data on the basis of co-occurrence in the network of network events in individual network categories with network events in other network categories.

According to examples of the present disclosure, the manager may be a virtualised network function.

According to another aspect of the present disclosure, there is provided a system for managing network event data, the system comprising: an input module configured to receive incoming network event data, the network event data comprising notifications of network events occurring within a network; an identifying module configured, for individual notified network events within the received network event data, to identify a category of the notified network event; and a filtering module configured to filter the received network event data on the basis of co-occurrence in the network of network events in individual network categories with network events in other network categories.

### BRIEF DESCRIPTION OF THE DRAWINGS

For a better understanding of the present invention, and to show more clearly how it may be carried into effect, reference will now be made, by way of example, to the following drawings, in which:

FIG. 1 is a flow chart illustrating process steps in a method for managing network event data;

FIG. 2 is a flow chart illustrating process steps in another example of method for managing network event data;

FIGS. 3a and 3b show a flow chart illustrating process steps in a further example of method for managing network event data;

FIG. 4 is a block diagram illustrating functional units in a Manager;

FIG. 5 is a block diagram illustrating functional units in a System;

FIG. 6 is a graph illustrating an example implementation of aspects of the present disclosure.

### DETAILED DESCRIPTION

Aspects of the present disclosure provide a manager and method which may be used for managing network event data. Examples of the disclosure offer a self-learning system that allows for the management of network event data without requiring input from a network expert to define logic for identifying or filtering network events. Example methods of the present disclosure use the concept of categories of network events, and comprise the steps of receiving network event data and filtering the received network event data on the basis of co-occurrence in the network of network events in individual network categories with network events in other network categories. The categories of network events may be defined by a network operator or administrator, or in some examples may be learned, for example on the basis of historical network data as discussed in further detail below. According to some examples of the present disclosure, the co-occurrence of network events in different categories may be used to define a noise score for events in different categories, and filtering of the network data may then be performed on the basis of the defined noise score for the category to which an event belongs. Examples of the present disclosure thus facilitate the filtering of network event data without requiring expert input or network knowledge.

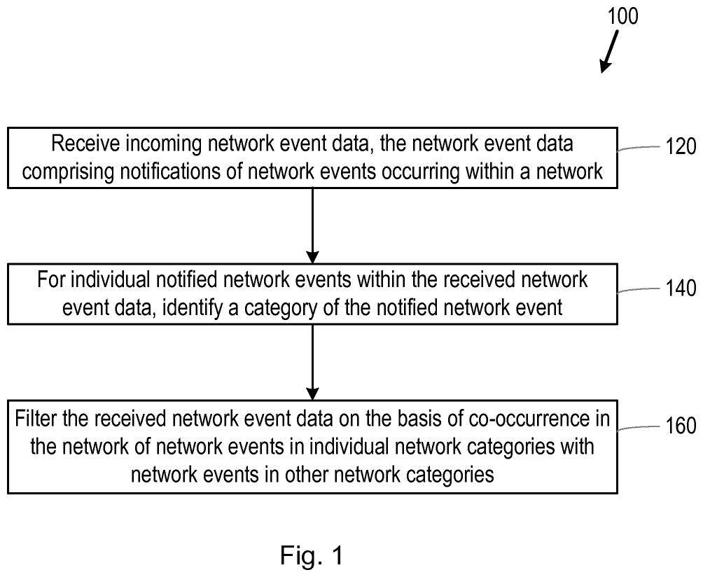

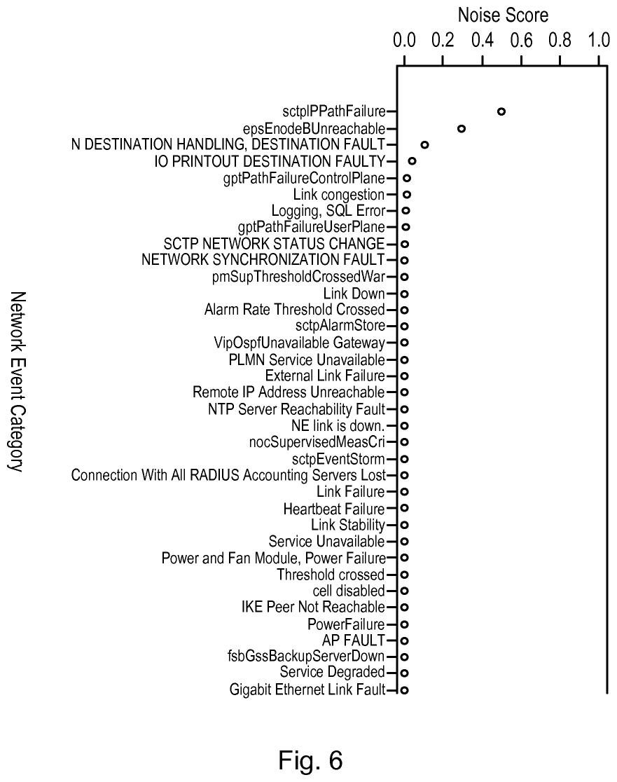

FIG. 1 is a flow chart 100 illustrating process steps in a method for managing network event data. The method may be performed in a physical or virtual node which may for example be part of a management and/or operations system. In some examples the method may be performed by a physical or virtual manager, as discussed more fully with reference to FIG. 6. Referring to FIG. 1, in a first step 120, the method comprises receiving incoming network event data, the network event data comprising notifications of network events occurring within a network. According to different examples of the present disclosure, the incoming network event data may comprise real-time network event data or may comprise historic network event data. In step 140 the method then comprises, for individual notified network events within the received network event data, identifying a category of the notified network event. As discussed in greater detail below, in some examples of the method 100, categories of network events for a particular network may be defined, or may be determined or learnt, for example based on one or more attributes of a network event. Referring still to FIG. 1, the method then comprises, in step 160, filtering the received network event data on the basis of co-occurrence in the network of network events in individual network categories with network events in other network categories.

Method 100 therefore provides a method according to which network event data is filtered on the basis of co-occurrence of network events in individual categories with network events in other categories of network event. Co-occurrence of network events in different categories is thus used as an indication of the likelihood that any given network event is a noise event, and thus of less value for the purposes of fault diagnosis and other network performance analysis. Examples of the present disclosure thus leverage the insight that an event that tends to occur at the same time as many other events is less likely to provide valuable, actionable insight into a network issue than an event that tends to occur in isolation. For example, a generic error alarm may occur during a wide range of different network faults and incidents, and so may provide limited insight into the precise nature or root cause of a fault. The generic nature of this alarm is recognised according to examples of the present disclosure by its co-occurrence with a wide variety of other network events in different network event categories. In contrast, a network event that rarely co-occurs with other network events, or which only co-occurs with events in a single category (for example which only co-occurs with a generic alarm event), is more likely to be specific to a particular type of problem or incident, and so more likely to provide useful information for analysis and diagnosing of the problem. Examples of the present disclosure may prioritise such an event for subsequent analysis during the filtering of network event data.

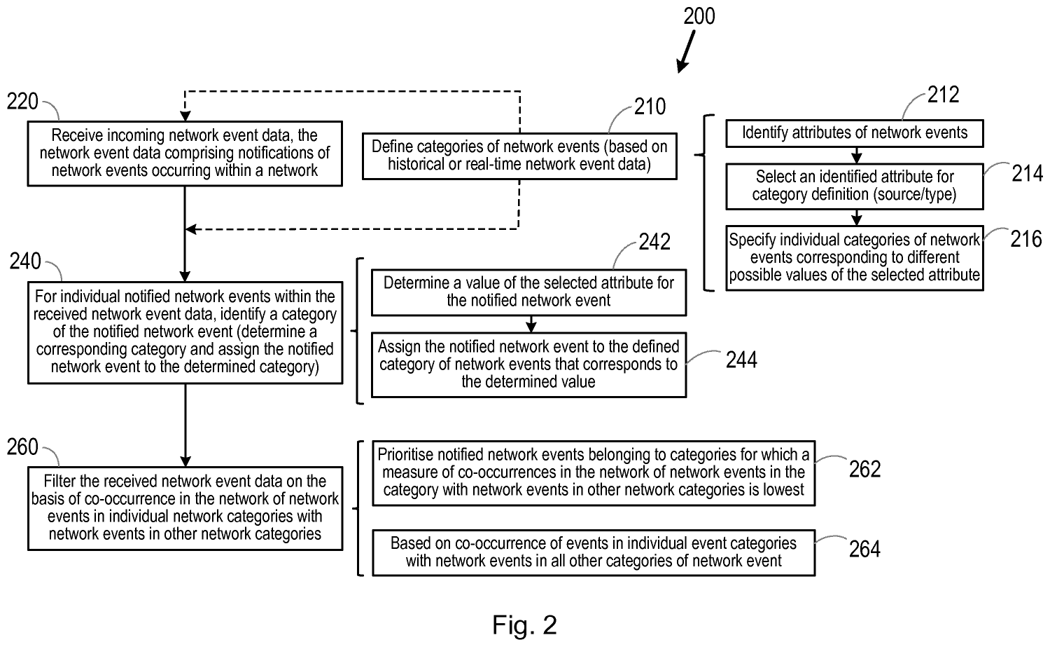

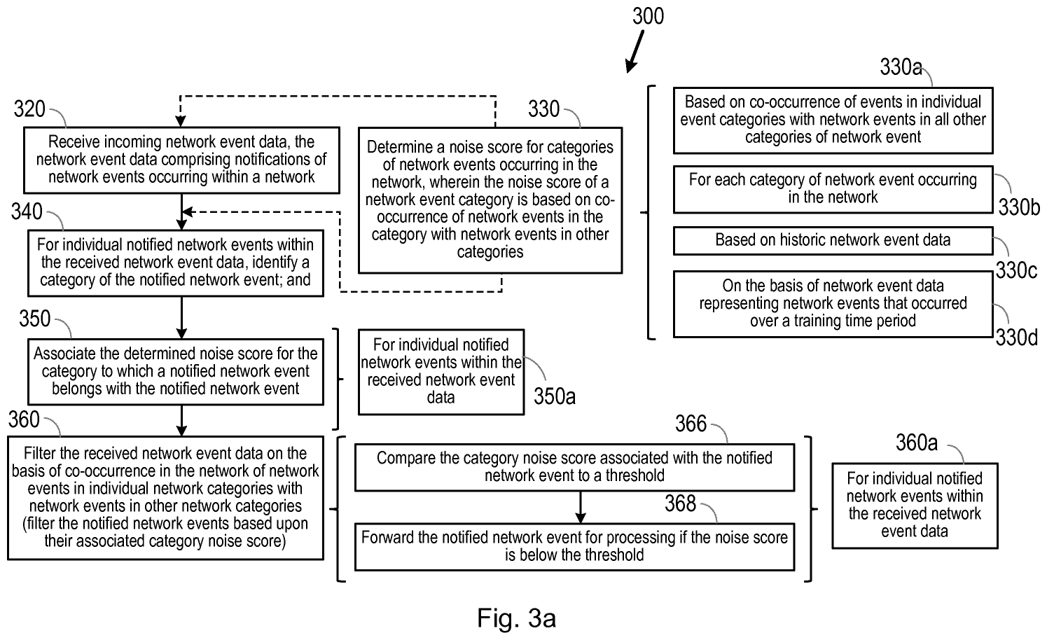

FIGS. 2, 3a and 3b are flow charts illustrating process steps in further examples of method 200, 300 for managing network event data. The steps of the methods 200 and 300 illustrate different ways in which the steps of the method 100 may be implemented and supplemented, to provide the above discussed and additional functionality. It will be appreciated that different combinations of the individual process steps in the methods 200 and/or 300 may be envisaged according to different implementation examples. The precise combination and ordering of the steps in the methods 200 and 300 is provided here merely as an example for the purpose of illustration. As for the method 100 above, the methods 200 and 300 may be performed in a physical or virtual node which may for example be part of a management and/or operations system. In some examples the method may be performed by a physical or virtual manager.

Referring initially to FIG. 2, the method 200 comprises a step 220 of receiving incoming network event data, the network event data comprising notifications of network events occurring within a network. As discussed above, the network event data may be real-time or historical data, and the network events represented in the data may comprise fault notifications, alarms, performance event notifications etc. The method 200 further comprises a step 210 of defining categories of network events. As illustrated in FIG. 2, the definition of categories of network events in step 210 may be based on historical network event data, which may for example comprise data collected over a training time period, as discussed in further detail below with reference to the generation of a noise score. In other examples, the definition of categories of network events in step 210 may be based on real-time incoming network event data, such that definition of network categories is performed in real-time. The step 210 may in different embodiments of the method 200 take place before or after the step 220 of receiving incoming network event data. In one example, the step 220 of receiving incoming network event data may comprise receiving real-time network event data, and the step 210 of defining categories of network events may be performed before the step 220, for example on the basis of historical network event data obtained from or provided by a repository of such data. In other examples, the step 220 of receiving incoming network event data may comprise receiving historical network event data, and the step 210 of defining categories of network events may take place after the step 220, on the basis of the historical network event data received in step 220.

As illustrated in FIG. 2, the step 210 of defining categories of network events may comprise a first sub-step 212 of identifying attributes of network events. An attribute of a network event may comprise any parameter or characteristic associated with the network event, such as may be included in a field of an event notification. Such attributes may include for example an identification or characterisation of hardware or software generating the event, or one or more properties of the event such as a specific problem, alarm severity, probable cause etc. Such attributes may be identified in some or all of the notified network events in the historical network event data on which the categories are to be based. Defining categories of network events may further comprise the sub-step 214 of selecting an identified attribute for category definition. The selected attribute may in some examples indicate a source of a network event. A source of a network event may be indicative of an origin of the network event and may thus comprise an identification or characterisation of a part of the network in which the event originated. The part of the network may be identified or characterised using hardware, software, network partition, network topology, network slice etc. Examples of a network event attribute indicating a source of the network event may include node ID, node type, application ID, application type, network layer, network slice etc. Example values of an attribute indicating a source of an event may include:
10BU1572C
10BU1612B
BSC2130
CSW_NODE
AAS_server_app

In other examples the selected attribute may indicate a type of network event. The type of network event may comprise an identification or characterisation of a class or family of events to which the network event belongs. Examples of a network event attribute indicating a type of the network event may include probable cause, specific problem, alarm severity etc. Example values of an attribute indicating a type of an event may include:
gtpPathFailureUserPlane
SCTP NETWORK STATUS CHANGE
NETWORK SYNCHRONIZATION FAULT
pmSupThresholdCrossedWa
connectionstatus: connected-disconnected
mirrormibsynchstatus: unsynchronized-topology

In some examples, multiple identified attributes may be selected for category definition, such that categories are for example defined on the basis of specific problem and alarm severity, or node type and network slice, etc.

Finally, the step 210 of defining categories of network events may comprise the sub-step 216 of specifying individual categories of network events corresponding to different possible values of the selected attribute. The possible values of a selected attribute comprise the allowed quantitative or qualitative metrics or indicators of the attribute for a particular network event in the network. Thus for an example selected attribute of ‘node type’, possible values of the selected attribute may include eNodeB, Mobility Management Entity (MME), Serving Gateway (S-GW), Home Subscriber Service (HSS) etc. in an LTE network, or gNodeB, Access and Mobility Management Function (AMF), Authentication Server Function etc. in a 5G network, or different router types in a transport network, etc. According to such an example, a category may be specified for each possible value. Thus in an LTE network, a category may be specified for eNodeB nodes, another category for MME nodes etc. For an example selected attribute of ‘alarm severity’, possible values of the selected attribute may include ‘HIGH’, ‘MEDIUM’ or ‘LOW’. A category may therefore be specified for each of the ‘HIGH’, ‘MEDIUM’ and ‘LOW’ values. For a further example selected attribute of ‘specific problem’, possible values of the attribute may include ‘Link Failure, Link Stability, Power Failure, Logging, SQL Failure, Heartbeat Failure etc. A category may be specified for each of these possible attribute values.

The selection of one or more attributes for category definition may be performed by an operator or administrator or may be performed by a machine learning algorithm such as a clustering algorithm which takes as input the historical network event data and returns clusters of events in the data, the clusters defined according to one or more attributes of the events. In a network, and particularly in a heterogeneous, multivendor network, some attributes of network events may be specified differently according to the software or hardware with which the event originated. For example, in a single network equivalent alarm events may variously be specified as ‘degraded service’ events or as ‘service degradation’ events. A clustering algorithm may thus be employed to accommodate such variations, and ensure that equivalent events having differently specified attributes are correctly categorised. In the above example, a clustering algorithm may be employed to group ‘degraded service’ and ‘service degradation’ attributes in the same category. In such examples, natural language processing (NLP) techniques may also be employed to group events such as these to the same category. The NLP techniques may support the clustering algorithms by determining word similarity between the names of network events and/or network event attributes to help with defining categories and ensuring that events are correctly assigned to a category.

Referring still to FIG. 2, the method 200 further comprises, after the receipt of incoming network data and the definition of categories as discussed above, the step 240 of identifying a category of notified network events. As illustrated in FIG. 2, this may comprise determining a category to which the notified network event corresponds, and assigning the notified network event to the determined category. The category may be determined from among a set of predefined default categories or, in examples of the method in which the step 210 of defining categories of network events is performed, the category may be determined from among the defined categories. Step 240 may therefore comprise a first sub-step 242 of determining a value of the selected attribute for a notified network event (the selected attribute having been selected in step 214 for category definition as part of the step 210 of defining categories of network events), and a second sub-step 244 of assigning the notified network event to the defined category of network events that corresponds to the determined value. Thus for categories defined on the basis of a selected attribute of ‘specific problem’, step 244 may comprise assigning a notified event to the category corresponding to the value of that attribute that was determined in sub-step 242. These sub-steps may be repeated for all notified network events in the incoming network event data.

The method 200 further comprises the step 260 of filtering the received network event data on the basis of co-occurrence in the network of network events in individual network categories with network events in other network categories. As illustrated in sub-step 262, this may comprise prioritising notified network events belonging to categories for which a measure of co-occurrences in the network of network events in the category with network events in other network categories is lowest. The precise nature of the measure of co-occurrences may vary according to different embodiments of the method 200. In some embodiments, the measure of co-occurrences may comprise a count of a total number of co-occurrences in the network of network events in the category with network events in other network categories. Such examples prioritise notified events belonging to categories which contain network events having the least number of co-occurrences with network events in other categories in the network. In other examples, the measure of co-occurrences may comprise a count of a total number of categories containing events with which events in the category co-occur in the network. Such examples prioritise notified network events belonging to categories containing events having co-occurrences in the network with events in just one or a small number of other network categories. In still further examples, the measure may place increased importance on co-occurrence with events in categories that themselves contain events which co-occur with events in many other categories. In such examples, the count may for example be weighted. In some examples, the measure of co-occurrences may comprise a noise score, as discussed in further detail below with reference to FIG. 3.

As discussed above, network events in a category with “low co-occurrence” with network events in other categories are events that tend to occur more in isolation than in common with events in other categories. “Low co-occurrence” may be measured by a simple count of the number of co-occurrences, or by the variety of different network categories with which events in a single network category co-occur, and may take into account the co-occurrence data of the other categories with which events in a category co-occur. Such “low co-occurrence” events are most likely to provide usable intelligence for subsequent analysis of network problems or incidents. In the example of a FM system, such events may be more indicative of the root cause of a fault compared to events that co-occur more frequently with other categories of events, as such events will contain less useful information and may be considered as noise. Step 206 may additionally or alternatively comprise sub-step 264, which comprises filtering based on co-occurrence of events in individual event categories with network events in all other categories of network event. By observing and determining the co-occurrence of events in an individual category with all other categories of network event, a relatively complete representation of the co-occurrence between events of different categories can be determined. Thus by determining the co-occurrence of network events in one category with all other categories of network events, the filtering step 260 may most accurately filter noisy network event data from more useful network event data. In further examples, the filtering step 260 may be based on co-occurrence of events in individual categories with network events in a subset of all other categories of network events. In such examples, certain categories of network event may be omitted from the co-occurrence analysis, for example to reduce processing time or resource requirements. In such examples, the subset of network event categories may be selected to provide an acceptable compromise between accuracy and resource requirements for carrying out the method 200.

The method 200 thus illustrates one way in which the co-occurrence based filtering of the method 100 may be implemented. The method 200 illustrates in particular one method for managing the definition of categories and the identification of a category of a particular notified network event. This management of network event categories may in some examples be combined with the determination of a noise score, as illustrated in method 300 shown in FIGS. 3a and 3b.

As discussed above, FIGS. 3a and 3b illustrate process steps in another example of method for the management of network event data. Some or all of the steps and sub-steps of the method 300 may be combined with some or all of the steps of the method 200, according to different implementations and examples of the present disclosure.

Referring first to FIG. 3a, the method 300 comprises a step 320 of receiving incoming network event data, the network event data comprising notifications of network events occurring within a network. As discussed above, the network event data may be real-time or historical data, and the network events represented in the data may comprise fault notifications, alarms, performance event notifications etc. The method 300 may further comprise a step of defining categories of network events as discussed with reference to FIG. 2. The method 300 further comprises a step 330 of determining a noise score for categories of network events occurring in the network, wherein the noise score of a network event category is based on co-occurrence of network events in the category with network events in other categories. The step of determining the noise score 330, may comprise, at step 330a, determining the noise score based on co-occurrence of events in individual event categories with network events in all other categories of network event. This may provide the most accurate noise score available for a given set of network event data, as all the categories of events will be considered. In other examples, co-occurrence with only a subset of other network event categories may be considered. The step 330 of determining the noise score, may in some examples comprise the step 330b of determining the noise score for each category of network event occurring in the network. Every network event may in such examples be assigned a noise score corresponding to its category and filtered based on its assigned noise score.

The determining of a noise score in step 330 may be based on historical network event data, as illustrated in step 330c. This may for example comprise data representing network events that occurred over a training time period, as illustrated in step 330d and discussed in greater detail with reference to FIG. 3b. The training time period may be the same training time period as may be used for the definition of network event categories as discussed above. Historical network event data obtained over a training time period may thus be used both to define network event categories and to determine a noise score for the defined categories. The step 330 may in different examples of the method 300 take place before or after the step 320 of receiving incoming network event data. In one example, the step 320 of receiving incoming network event data may comprise receiving real-time network event data, and the step 330 of determining a noise score for categories of events may be performed before the step 320, for example on the basis of historical network event data obtained from or provided by a repository of such data. In other examples, the step 320 of receiving incoming network event data may comprise receiving historical network event data, and the step 330 of determining a noise score for categories of events may therefore take place after the step 320, on the basis of the historical network event data received in step 320. An example process for determining a noise score at step 330 is illustrated in FIG. 3b and discussed in further detail below.

Referring still to FIG. 3a, the method 300 further comprises, after the receipt of incoming network data and the determining of noise scores as discussed above, the step 340 of identifying a category of notified network events. In some examples, this may comprise identifying a category from among categories defined according to the process steps discussed above with reference to FIG. 2. The method 300 further comprises, in step 350, associating the determined noise score for the category to which a notified network event belongs with the notified network event. As illustrated at step 350a, this association of a network category noise score with an individual notified network event may be performed for some or all of the individual notified network events within the received incoming network event data. It will be appreciated that all network events belonging to a particular category will thus be associated with the noise score determined for that category.

The method 300 further comprises the step 360 of filtering the received network event data on the basis of co-occurrence in the network of network events in individual network categories with network events in other network categories. As illustrated in FIG. 3a, and as will be appreciated from the above discussion, this filtering may be achieved by filtering the notified network events based upon their associated category noise score, as the associated category noise score is determined based upon the co-occurrence of events in network categories. The filtering step 360 may, in some examples, comprise the sub-step 366 of, for individual notified network events within the received network event data, comparing the category noise score associated with the notified network event to a threshold. The noise score may thus provide an efficient and universal metric across all categories of network event to evaluate the likelihood that any individual network event is a noise event. A threshold may be set to define what level of noise score represents a noise event, and this threshold may be used to filter the received network event data. In some examples, the noise score for all categories of network event may be normalized to facilitate comparison with a single threshold value. In some examples, the threshold may be an absolute value or a relative value. In some examples, the threshold may be set by a network operator or administrator. Network events belonging to categories with a noise score below the threshold level may be considered to represent useful data for further analysis, and network events belonging to categories with a noise score at or above the threshold level may be considered as noise events and so filtered out from the stream of incoming data. The filtering step 360 may further comprise the sub-step 368 of forwarding a notified network event for processing if the noise score associated with the network event is below the threshold. In this manner, the network events that are most likely to provide useful intelligence for further analysis are forwarded for processing, and the overall volume of network data for processing is reduced by filtering out those network events that are most likely to be noise events, and so offer no or very limited useful intelligence for analysis or diagnostic purposes.

In some examples, the threshold may be determined on the basis of a target percentage reduction in the total amount of received network data that is forwarded for processing. For example, a target reduction of 50% in the received network data to be forwarded for processing may be selected. An absolute value for the threshold may then be determined that will achieve this target percentage reduction. In some examples, a network operator or administrator may select the target percentage reduction, and the appropriate absolute threshold value may then be determined automatically.

The method 300 of FIGS. 3a and 3b illustrates one way in which a noise score may be used to achieve filtering of noise events based on co-occurrence of events in individual categories with events in other categories of network event. The noise score provides an efficient way to compare the co-occurrence frequency of one category of network event to the co-occurrence frequency of other categories of network event. In particular, the noise score enables a management system or node to differentiate efficiently and quickly between network event data that is likely to be useful for network analysis and diagnosis and noisy network event data that will provide limited value in such analysis. In some examples, the noise score may be normalized to facilitate comparison. The higher the noise score for a category of network events, the higher the probability that the events in that category are noisy network event data.

It will be appreciated that according to examples of the method 300, the determination of noise scores for categories of events may be performed before the receipt of real-time network event data in step 320. The noise scores (and network event categories as discussed with reference to method 200), may be determined on the basis of historical network data, for example collected over a training time period. Incoming real-time network event data may then be quickly filtered and forwarded for processing as appropriate, as the real-time steps of identifying the defined category to which a network event belongs, and associating the category noise score with the network event, do not require extensive processing time.

FIG. 3b illustrates an example process for determining a noise score at step 330 of the method 300. FIG. 3b also illustrates additional steps which may be performed as part of the method 300 to allow for updating of a determined noise score for categories of network events. Referring to FIG. 3b, the step 330 of determining a noise score for categories of network events in a network, wherein the noise score of a network event category is based on co-occurrence of network events in the category with network events in other categories, may comprise sub-steps 332, 334, 336 and 338 as illustrated. Sub-step 332 comprises generating a temporal association graph of network event categories, wherein the temporal association graph comprises a weighted graph having a vertex set of network event categories and an edge set of association relations between network event categories. Each network event category is therefore expressed as a vertex of the weighted graph, and the edges between the vertices represent the association between each vertex i.e. between each category of network event. From the associations between the categories of network events in the weighted graph, the noise score may be determined as discussed below.

Sub-step 332 of generating the temporal association graph may comprise sub-step 332a of determining an association relation between network event categories according to a number of co-occurrences in the network of network events in the categories, wherein a co-occurrence of network events in two network event categories comprises an occurrence of an event in each of the network event categories within a co-occurrence time window. An association relation between network event categories is therefore determined by observing co-occurrence of network events from two separate categories in the network, where co-occurrence is defined as an occurrence of an event in each of the categories within a defined time window. The association may be recorded as a single count for every time a co-occurrence occurs between two network events of separate categories. The co-occurrence may be observed in a given time window and every time two network events of different categories co-occur in that time window, a co-occurrence count may be recorded. This process may be carried out for all network events and for all categories of network event to build the temporal association graph.

In some examples, the association relation between the categories of network event may be determined by observing the co-occurrence of network events in multiple time windows. In some examples, generating the temporal association graph may comprise obtaining historic network event data for a network and dividing the historic network event data into a number of time windows, where the co-occurrence between the categories of network events is determined for each time window. The historic data may represent a training time period, which may for example be of a duration of a few days to a few weeks. The method 300 may determine the co-occurrence relations between categories of network events, and hence the appropriate noise scores, based on this historic data. The method may then use the determined noise scores for filtering of real-time incoming network event data. The time window may be chosen based on network domain knowledge or chosen based on the available historic data. The time window may for example represent a period of time within which network events relating to the same underlying issue but generated by different systems or nodes may be received at a management entity. The time window may for example be of the order of 5, 10 or 15 minutes. The time window may be a sliding time window or a rolling time window repeated across the entirety of a historic network data set. Determining the association relation between categories of network events may then comprise summing a number of co-occurrences over multiple time windows. In one aspect, the co-occurrence counts across all time windows in a training period may be summed together.

In some examples, the association relation between two categories of network event may be determined according to the following expression:

$${e}_{ij} = {\sum }_{k = 1}^{n} min ( {v}_{i}^{wk} , {v}_{j}^{wk} ) \qquad ( 1 )$$

Where:

vᵢ and vⱼ are two categories of network event;
eᵢⱼ is the association relation between the network event categories vᵢ and vⱼ;
wk is a co-occurrence time window;
vᵢ^{wk}, vⱼ^{wk} are occurrence counts of events in event categories vᵢ and vⱼ during the co-occurrence time window wk, and
n is the total number of co-occurrence time windows in a training time period.

An edge may be created between two vertices representing event categories vᵢ and vⱼ if the association relation eᵢⱼ is greater than zero. The weight applied to the edge may be equal to the value of eᵢⱼ. eᵢⱼ takes into account the co-occurrence count between two categories of network event across all time windows, which may be based on historic data and taken over a training time period. The higher the value of eᵢⱼ, the higher the weight of the edge between the two categories of events vᵢ and vⱼ. Edges according to equation (1) may be determined for all categories of network event that are defined in a network event data set

The edges of the temporal association graph may be formed based on the association relation between two vertexes or categories of network events. This is based on the co-occurrence of events in the two categories of network events. The edges of the graph, in general, will have a directional component, with the association relation between two vertices vᵢ and vⱼ being expressed as an association relation from vᵢ to vⱼ and an association relation from vⱼ to vᵢ. In the present example of an association relation based on occurrence counts as set out in equation (1), the weight of the edge will be the same in each direction between two vertexes. However, in different examples which may use different approaches to the calculation of an association relation, the weight of an edge in a first direction from a vertex vᵢ to a vertex vⱼ may be different to the weight of an edge in the opposite direction from a vertex vⱼ to a vertex vᵢ.

Referring still to FIG. 3b, step 330 of determining a noise score for categories of network events in a network may further comprise the sub-step 334 of calculating a Markov model based on the temporal association graph. The Markov model models approximate event generation through time, and so provides a prediction of a future state of the network, as represented by the mapped event data, based on the present state of the network. As such, the Markov model describes how the probability of occurrence of events in a category depends upon occurrences of events in other categories. This may be used as described below to generate a noise score, with a higher noise score being associated with those categories for which the probability of event occurrence is highly dependent upon the occurrence of events in other categories (that is categories of events that tend to occur concurrently with other events rather than in isolation).

In some examples, the Markov model may be calculated according to:

M=D⁻¹A (2)

Where:

M is the Markov model;
D is the out degree matrix of the temporal association graph; and
A is the weight adjacency matrix of the temporal association graph.

The out degree matrix D may be generated according to:

$${D}_{ii} = diag ( {\sum }_{i \neq j , j = 1} {A}_{ij} ) \qquad ( 3 )$$

The Markov model provides a representation of the information contained in the temporal association graph, providing an indication of how a probability of occurrence of events in any one category is dependent upon occurrence of events in other categories.

Referring again to FIG. 3b, the step 330 of determining a noise score for categories of network events in a network may further comprise the sub-step 336 of setting an eigenvector of the Markov model that corresponds to the eigenvalue of 1 to be a noise score vector of the network noise event categories represented in the temporal association graph. The Markov model is a stochastic matrix, and as such, according to the Perron-Frobenius theorem, the Markov model matrix must have an eigenvalue equal to one. The eigenvector of the Markov model matrix corresponding to the eigenvalue of 1 may be expressed according to:

\vec{n}M=\vec{n} (4)

Where:

n is an Eigenvector of the Markov model M corresponding to an eigenvalue of 1; and
M is the Markov model

The resulting eigenvector will then comprise a plurality of components expressed in a vector form. Each component of the Eigenvector corresponds to a category of network event and provides a numeric representation of the probability information contained in the Markov model for that category. The noise score for each category of network event may then be determined by setting the value of each component of the Eigenvector as the noise score for the corresponding category of network event. Determining an appropriate eigenvector of the Markov model therefore enables a representation to be made of the co-occurrence event information in the Markov model for each category of network event. The noise score may also be represented according to the expression:

$${n}_{i} = {\sum }_{j} {e}_{ji} \frac{{n}_{i}}{{Σ}_{i} {e}_{ji}} \qquad ( 5 )$$

Where:

nᵢ is an individual component of the Eigenvector of the Markov model M corresponding to an eigenvalue of 1, where the individual component nᵢ of the eigenvector is set to be the noise score for category vᵢ of network events; and
eᵢⱼ is the association relation between two network event categories vᵢ and vⱼ.

Referring again to FIG. 3b, the step 330 of determining a noise score for categories of network events in a network may further comprise the sub-step 338 of normalizing the noise score vector. In some examples, the noise score vector may be normalized according to the expression:

$$\vec{n} = \frac{\vec{n}}{\sqrt{\vec{n} \cdot \vec{n}}} \qquad ( 6 )$$

Where:

n is the Eigenvector of the Markov model corresponding to an Eigenvalue of 1.

By normalizing the noise score across all categories of network events, a universal metric may be obtained for comparison between network event categories of the likelihood that events in such categories may be noise events. Normalizing the noise scores for the categories of network event also allows for use of a single threshold value for filtering of network events. It will be appreciated that equation (6) represents an example equation that may be used to normalize the noise scores and it will be understood that other techniques exist which may be suitable for normalizing the noise score.

It will be appreciated that a noise score determined according to the process illustrated in FIG. 3b is based on event time information only. No network topology information or domain expert knowledge is used to determine the noise scores. The temporal association graph captures the temporal relation between event occurrences in different categories events. Graph theory is then applied to distil the intelligence captured in this graph to a single noise score for each category of events, wherein the noise score provides a numerical representation of the probability that events in a particular category are noise events. Normalising the noise scores allows for convenient comparison and filtering. It will further be appreciated that a noise score based on a temporal association graph as described above captures not only the impact upon noise probability of a network event category being associated with many different other network event categories, but also captures the impact, upon noise probability of a given category, of the noise probability of the categories to which the category is associated. Thus a high level of association with a category that itself has a high probability of containing noise events will contribute more greatly to the noise score of the category under consideration than a high level of association with a category that itself has a low probability of containing noise events.

Referring still to FIG. 3b, the method 300 may further comprise checking for occurrence of an update trigger in step 370, and, in step 380, updating a noise score of at least one network event category on occurrence of an update trigger. In some examples, the update trigger may comprise at least one of: a time based trigger 370a and/or an event based trigger 370b. A time based update trigger may be generated on a scheduled and/or periodic basis. An event based update trigger may be generated following the occurrence of one or more predefined network events. Such events may comprise changes to the network topology. Updating the noise scores for one or more categories based on an update trigger enables the method to continue to accurately filter network event data as the network changes and evolves. Such updates may be configured without the input of an expert network operator.

The method 300 of FIGS. 3a and 3b thus provides one example of how a noise score may be generated to represent co-occurrence between events in different network categories, and how such a score may be used for the filtering of network event data.

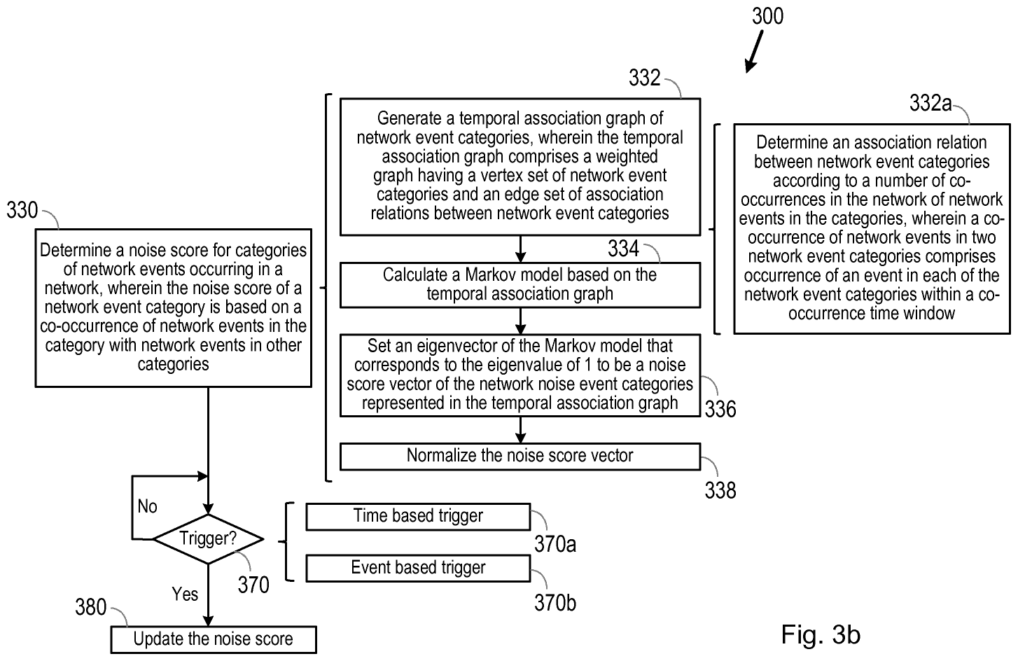

FIG. 4 is a block diagram illustrating functional units in a Manager 400, which may implement the methods 100, 200 and/or 300 according to examples of the present disclosure, for example on receipt of suitable instructions from a computer program 406. Referring to FIG. 4, the manager 400 comprises a processor 402 and a memory 404. The memory 404 contains instructions executable by the processor 402 such that the manager 400 is operative to conduct some or all of the steps of methods of 100, 200 and/or 300. The Manger 400 may be a single element or may be part of a distributed function, which may for example be a Virtualized Network Function. The Manger 400 also comprises an interface (not shown in the drawings) in communication with the processor 402. In one embodiment the interface, processor 402 and memory 404 may be connected in series, and in an alternative embodiment the interface, processor 402 and memory 404 may be interconnected in any other way, for example via a bus. The interface enables communication between the Manager 400 and network elements of a network (e.g. communications network 102).

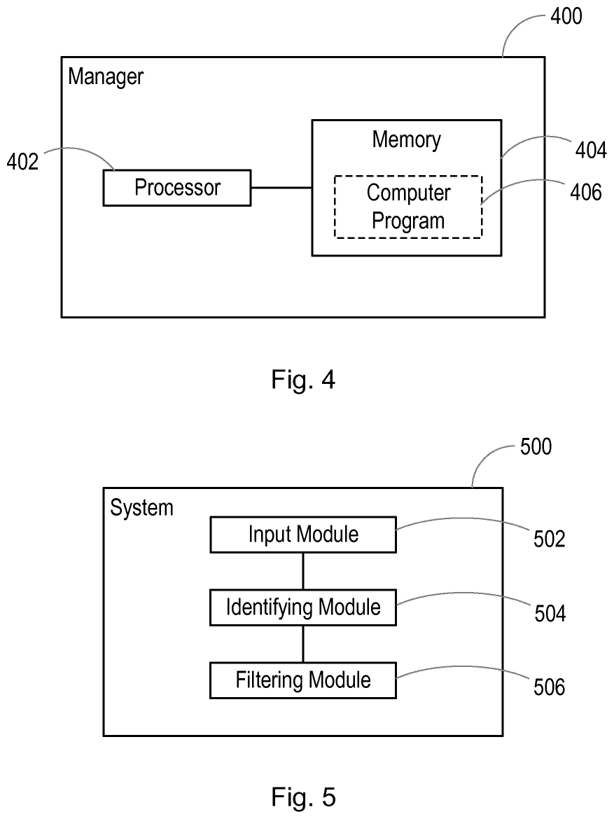

FIG. 5 is a block diagram illustrating functional units in an example system 500 which may implement the methods 100, 200 and/or 300 according to examples of the present disclosure, for example according to computer readable instructions received from a computer program. It will be understood that the units illustrated in FIG. 5 are functional units, and may be realised in any appropriate combination of hardware and/or software. The units may comprise one or more processors, or processing circuitry, and may be integrated to any degree.

Referring to FIG. 5, the system 500 comprises an input module 502 configured to receive incoming network event data, the network event data comprising notifications of network events occurring within a network. The system also comprises identifying module 504 configured to, for individual notified network events within the received network event data, identify a category of the notified network event. The system 500 further comprises filtering module 506 configured to filter the received network event data on the basis of co-occurrence in the network of network events in individual network categories with network events in other network categories. The system 500 may further comprise interfaces for facilitating communication between the modules and with a user. The system 500 may further comprise a learning module configured to define categories of network events and to determine a noise score for different categories of network events, as described above. The system 500 may further comprise a user control panel, which may be configured to enable a user to set a threshold for reduction of noise events in an incoming stream of network event data. The user control panel may enable a user to interact with the other components of the system to control what and how many network events are filtered out of the incoming data stream before the data stream is passed for subsequent analysis or processing.

As discussed above, examples of the present disclosure may be applied to management of network event data in a wide variety of telecommunication and computer networks and for varying use cases. One example use case for methods according to the present disclosure is in a fault management (FM) system in an Operations support system (OSS).

The complex, heterogeneous and multivendor environment of many existing communication networks means that a single network fault can result in the creation of a large number of network events. A substantial portion of the events generated as a consequence of a single fault may carry no or very little useful information for determining the cause of the fault. For example, logging type events may notify the same general “error” message for every logging incident. Events such as these contribute very little useful information on the source of a fault compared to other events, such as a ‘power failure’ event for example, which provides more useful information for identifying the cause of an incident.

When applied to a Fault Management use case, examples of the present disclosure may filter out the frequently occurring network event data that results from a fault and provides limited value in fault analysis, preserving the less frequently occurring network event data, which may provide more meaningful intelligence. In this manner, the network events that remain after the filtering process may be used to analyze and diagnose the cause of the fault more efficiently.

FIG. 6 is a graph illustrating determined noise scores for different categories of network events generated by an example implementation of a method according to the present disclosure in a FM system of a communications network. As discussed above, different categories of network events may be defined according to the specifics of a given use case or implementation, and categories based on event type, event source and mixed type or source events may all be used. In the example implementation of FIG. 6, the Specific Problem attribute of alarm event data is used for defining event categories, with a category being defined for each possible value of the Specific Problem attribute. A training period of several days was defined and the network event data assembled over that training period was used as input data for an example method as described herein. The noise scores determined for the different categories are illustrated in the graph of FIG. 6. The higher the determined noise score for a category, the higher the probability that the category may be considered to comprise noise events and thus may not provide useful information relating to the cause of a fault. A threshold may be set to filter out the noisy network event data from the more useful network event data. In the illustrated graph, the noise score for each category has been normalized to lie between 0 and 1.

Table 1 (below) provides a basis for evaluation of the effectiveness of the determined noise scores in filtering out noisy data, compared to analysis by domain experts. Table 1 illustrates the most frequently occurring alarm categories according to the Specific Problem attribute in the training network event data in the left hand column: ‘Top frequent alarms’. Table 1 also illustrates in the right hand column the alarm categories having the highest noise scores after running the example method of the present disclosure: ‘Top noise alarms’. Analysis by domain experts concluded that although the specific problem types ‘link failure’, ‘cell disabled’ and ‘service unavailable’ occur frequently in the network (all appearing in the top 15 most frequently occurring alarm types), they are not in fact noisy events, as they can provide useful information on the cause of a fault. It can be seen that the example method of present disclosure, in determining noise scores based on co-occurrence of events in different network categories, as opposed to simply basing the noise score on frequency of occurrence of events in a single category, has correctly assigned a low noise score to these frequently occurring event categories, with none of these categories appearing in the top 15 noise score categories. In contrast, the domain experts identified ‘Destination faults’ and ‘Logging, SQL Error’ as being noise events, despite them not appearing in the top frequent alarms list. It can be seen that the example method of the present disclosure has correctly identified these alarms categories as likely to contain noise events, as they appear in the top 7 noise alarms and have been given relatively high noise scores.

| | Top frequent alarms | Top noise alarms |
|---|---|---|
| 1 | sctpIPPathFailure | sctpIPPathFailure |
| 2 | External Link Failure | epsEnodeBUnreachable |
| 3 | epsEnodeBUnreachable | DATA OUTPUT, |
| | | AP COMMON |
| | | DESTINATION HANDLING, |
| | | DESTINATION FAULT |
| 4 | PLMN Service Unavailable | IO PRINTOUT DESTINATION |
| | | FAULTY |
| 5 | Remote IP Address | gtpPathFailureControlPlane |
| | Unreachable | |
| 6 | NTP Server Reachability | Link congestion |
| | Fault | |
| 7 | Link Stability | Logging, SQL Error |
| 8 | Link Failure | gtpPathFailureUserPlane |
| 9 | Heartbeat Failure | SCTP NETWORK STATUS |
| | | CHANGE |
| 10 | DATA OUTPUT, | NETWORK |
| | AP COMMON | SYNCHRONIZATION FAULT |
| | DESTINATION HANDLING, | |
| | DESTINATION FAULT | |
| 11 | Service Unavailable | pmSupThresholdCrossedWar |
| 12 | cell disabled | Link Down |
| 13 | Sync Reference PDV Problem | Alarm Rate Threshold Crossed |
| 14 | IO PRINTOUT DESTINATION | sctpAlarmStorm |
| | FAULTY | |
| 15 | Service Degraded | VipOspf Unavailable Gateway |

The example implementation illustrated in FIG. 6 and Table 1 thus illustrates the effectiveness of examples of the present disclosure, replicating the insights that may be achieved by domain experts purely on the basis of network event data, without the need for any input from domain experts to define logic or processing for the filtering or analysis of the network event data.

Aspects of the present disclosure, thus provide a method for managing network event data that comprises filtering network event data on the basis of co-occurrence of network events in network event categories with network events in other categories of network event. Owing to the ever-increasing size and complexity of managed networks, managing and analysing network event data is an ongoing challenge for network operators. Aspects of the present disclosure present a method that can manage network event data accurately without the input of a network operator or domain expert to oversee, design or carry-out the method.

Conventional methods of managing network event data require input from one or more individuals with expert-level knowledge of the network, designing bespoke systems to manage event data in a network. Additionally, knowledge of the network topology and configuration is required to design the logic underpinning such systems. These expert dependent approaches are becoming less and less viable as operators move towards complex, heterogeneous, multivendor network environments. Example methods according to the present disclosure allow for the filtering of network event data to remove events that are most likely to be noise events, providing little or no insight to underlying network issues. This filtering is performed purely on the basis of the network event data itself, with no externally applied insights into the network or its configuration. Filtering out data relating to noise events can greatly reduce the volume of data for subsequent analysis, maintaining only the most useful data for network analysis and diagnostics. Analysing only the most useful data provides a more efficient computational analysis process than if the most useful event data was obscured by large amounts of noise data. Aspects of the present disclosure therefore provide computational power saving measures.

A method according to examples of the present disclosure does not require the input of a network operator to define the categories or determine the noise scores. Aspects of the present disclosure do not require any network information, such as network topology to accurately manage network event data. Thus, aspects of the present disclosure provide an automated and transferable method of managing network events.

A method according to examples of the present disclosure may also update the noise scores and/or the categories of network events as the network evolves. The makeup of network event data may change with time or as a result of a network update such as that due to a change in topology. In such instances a method according to examples the present disclosure may update the noise scores and categories on the basis of an update trigger. The trigger may be time or event based. The update may therefore also be automated and so not require the input of a network operator. Aspects of the present disclosure may therefore evolve with the network to continue to provide accurate network event data managing capabilities in dynamic environments.

Conventional methods of designing network event management systems require expert-level knowledge of the configuration of the network to be managed. The network specific nature of many conventional methods of network data management render it highly unlikely that a network event management system designed for one network will be suitable for any other network. Examples of the present disclosure provide a system that is agnostic to the specifics of network configuration, drawing insights from the network event data itself. As such, examples of the present disclosure provide a system suitable for managing network event data from any network.

The methods of the present disclosure may be implemented in hardware, or as software modules running on one or more processors. The methods may also be carried out according to the instructions of a computer program, and the present disclosure also provides a computer readable medium having stored thereon a program for carrying out any of the methods described herein. A computer program embodying the disclosure may be stored on a computer readable medium, or it could, for example, be in the form of a signal such as a downloadable data signal provided from an Internet website, or it could be in any other form.

It should be noted that the above-mentioned examples illustrate rather than limit the disclosure, and that those skilled in the art will be able to design many alternative embodiments without departing from the scope of the appended claims. The word “comprising” does not exclude the presence of elements or steps other than those listed in a claim, “a” or “an” does not exclude a plurality, and a single processor or other unit may fulfil the functions of several units recited in the claims. Any reference signs in the claims shall not be construed so as to limit their scope.

1. A method for managing network event data, the method comprising:
receiving incoming network event data, the network event data comprising notifications of network events occurring within a network;
for individual notified network events within the received network event data, identifying a category of the notified network event; and
filtering the received network event data on the basis of co-occurrence in the network of network events in individual network categories with network events in other network categories wherein filtering the received network event data on the basis of co-occurrence of network events in individual network categories with network events in other network categories comprises prioritising notified network events belonging to categories for which a measure of co-occurrences of network events in the category with network events in other network categories is lowest.

2. (canceled)

3. A method as claimed in claim 1, wherein filtering the received network event data on the basis of co-occurrence in the network of network events in individual network categories with network events in other network categories comprises filtering based on co-occurrence of events in individual event categories with network events in all other categories of network event.

4. A method as claimed in claim 1, wherein identifying a category of a notified network event comprises:
determining a category of network events to which the notified network event corresponds; and
assigning the notified network event to the determined category.

5. A method as claimed in claim 1, further comprising defining categories of network events based on at least one of:
historical network event data;
real-time incoming network event data.

6. A method as claimed in claim 5, wherein defining categories of network events comprises:
identifying attributes of network events;
selecting an identified attribute for category definition; and
specifying individual categories of network events corresponding to different possible values of the selected attribute.

7. A method as claimed in claim 6, wherein identifying a category of a notified network event comprises:
determining a value of the selected attribute for the notified network event; and
assigning the notified network event to the defined category of network events that corresponds to the determined value.

8. A method as claimed in claim 6 wherein, the attribute indicates a source of the network event.

9. A method as claimed in claim 6 wherein the attribute indicates a type of the network event.

10. A method as claimed any claim 1, further comprising:
determining a noise score for categories of network events occurring in the network, wherein the noise score of a network event category is based on co-occurrence of network events in the category with network events in other categories; and
for individual notified network events within the received network event data, associating the determined noise score for the category to which the notified network event belongs with the notified network event;
wherein filtering the received network data comprises filtering the notified network events based upon their associated category noise score.

11. A method as claimed in claim 10, wherein filtering the received network event data comprises, for individual notified network events within the received network event data, comparing the category noise score associated with the notified network event to a threshold, and forwarding the notified network event for processing if the noise score is below the threshold.

12. A method as claimed in claim 10, wherein determining a noise score for categories of events occurring in the network comprises determining the noise score based on co-occurrence of events in individual event categories with network events in all other categories of network event.

13. A method as claimed in claim 10, wherein determining a noise score for categories of network events occurring in the network comprises determining a noise score for each category of network event occurring in the network.

14. A method as claimed in claim 10, wherein determining a noise score for categories of network events occurring in the network comprises determining a noise score based on historic network event data.

15. A method as claimed in claim 10, wherein determining a noise score for categories of network events occurring in the network comprises determining the noise score on the basis of network event data representing network events that occurred over a training time period.

16. A method as claimed in claim 10, further comprising updating a noise score of at least one network event category on occurrence of an update trigger.

17. (canceled)

18. A method as claimed in claim 10, wherein determining a noise score for categories of network events occurring in the network comprises generating a temporal association graph of network event categories, wherein the temporal association graph comprises a weighted graph having a vertex set of network event categories and an edge set of association relations between network event categories.

19. A method as claimed in claim 18, wherein generating a temporal association graph of network event categories comprises determining an association relation between network event categories according to a number of co-occurrences in the network of network events in the categories, wherein a co-occurrence of network events in two network event categories comprises occurrence of an event in each of the network event categories within a co-occurrence time window.

20.-28. (canceled)

29. A computer program product comprising non transitory computer readable media having stored thereon a computer program comprising instructions which, when executed on at least one processor, cause the at least one processor to carry out a method according to claim 1.

30. A manager for managing network event data, the manager comprising a processor and a memory, the memory containing instructions executable by the processor such that the manager is operable to:
receive incoming network event data, the network event data comprising notifications of network events occurring within a network;
for individual notified network events within the received network event data, identify a category of the notified network event; and
filter the received network event data on the basis of co-occurrence in the network of network events in individual network categories with network events in other network categories wherein to filter the received network event data on the basis of co-occurrence of network events in individual network categories with network events in other network categories the manager is operable to prioritise notified network events belonging to categories for which a measure of co-occurrences of network events in the category with network events in other network categories is lowest.

31.-35. (canceled)
